(19) United States
(12) Patent Application Publication
(10) Pub. No.: US 2019/0329752 A1
(43) Pub. Date: Oct. 31, 2019

(54) ELECTRICALLY OPERATED BRAKE DEVICE FOR VEHICLE

(71) Applicant: ADVICS CO., LTD., Kariya-shi, Aichi-ken (JP)

(72) Inventors: Takayuki WAZAKI, Toyota-shi, Aichi-ken (JP); Shinichiro YUKOKU, Seto-shi, Aichi-ken (JP)

(73) Assignee: ADVICS CO., LTD., Kariya-shi, Aichi-ken (JP)

(21) Appl. No.: 16/467,771

(22) PCT Filed: Dec. 15, 2017
(86) PCT No.: PCT/JP2017/045039

§ 371 Date: Jun. 7, 2019

(30) Foreign Application Priority Data
Dec. 15, 2016 (JP) 2016-242963
Dec. 15, 2016 (JP) 2016-242964

(51) Int. Cl. B60T 13/74; F16D 65/18; F16F 1/06; F16F 1/10

(52) U.S. Cl. CPC B60T 13/74; F16D 65/18; B60T 17/18; F16F 1/10; F16F 1/06

(57) ABSTRACT

An electrically operated brake device includes an electric motor pressing friction member against a rotating member, and a returning mechanism moving the friction member in a direction away from the rotating member when the electric motor is not energized. The returning mechanism includes a spiral spring and a housing. The spiral spring includes a restraint section. The housing includes a holding surface. When the electric motor is rotated in a forward direction, the restraint section presses the holding surface, and the spiral spring gives a returning torque in a reverse direction. When the returning torque exceeds a predetermined torque, the restraint section slips out of the holding surface. The holding surface is inclined with respect to a normal line surface including a contact part between the restraint section and the holding surface and an axis line of the rotating shaft.

### TECHNICAL FIELD

The present invention relates to an electrically operated brake device for a vehicle.

### BACKGROUND ART

The present applicant, as described in Patent Literature 1, has developed “an electrically operated brake device which intends to return a piston to an initial position even though reverse rotating drive of an electric motor becomes impossible, includes a rotating shaft supported in an energy accumulating mechanism (returning mechanism) such that the rotating shaft can rotate integrally with the output shaft of the electric motor, elastically transforms a spiral spring in the energy accumulating mechanism by forward rotation of the rotating shaft to accumulate elastic energy, and releases the elastic energy accumulated in the spiral spring in a reverse rotating state of the rotating shaft to give a reverse rotating torque to the rotating shaft”.

In a returning mechanism in the above electrically operated brake device, a torque limiter which is disposed between one end of the spiral spring (elastic body) and the housing, regulates relative rotation to the housing of the elastic body when the rotating shaft is forwardly rotated by a torque lower than a first predetermined value, and allows the relative rotation to the housing of the elastic body when the rotating shaft is forwardly rotated by a torque equal to or higher than the first predetermined value.

Patent Literature 1 exemplifies, for example, the following torque limiters as the torque limiter.

(1) A torque limiter which has a folded part folded in the form of an arc is formed at one end of the spiral spring on the outer peripheral side and which is fitted on the concave part of the inner peripheral surface of a case.

(2) A torque limiter in which, in addition to the configuration (1), an inner case and a leaf spring are disposed.

(3) A torque limiter in which a rotating shaft can be used in both forward and reverse rotations.

In the above configuration (1), since the spiral spring is fixed by fitting between the folded part and the concave part, a returning torque (set value of the torque limiter) is hard to be set to a large value. Furthermore, in the configurations (2) and (3), as a returning mechanism, a new additional member such as an inner case is necessary. Thus, a configuration which is simpler than the configuration exemplified in Patent Literature 1 and can set a large value as a returning torque is desired.

### CITATIONS LIST

### Patent Literature

Patent Literature 1: JP 2013-024389 A

### SUMMARY OF INVENTION

### Technical Problems

It is an object of the present disclosure to provide an electrically operated brake device which is applied to an electrically operated brake device for a vehicle, has a simple configuration in a returning mechanism employing a spiral spring, can set a large value as a returning torque.

### Solutions to Problems

An electrically operated brake device for a vehicle according to the present disclosure includes an electric motor (MTR) pressing a friction member (MS) against a rotating member (KT) rotating together with a wheel (WH) of a vehicle, and a returning mechanism (MDK) moving the friction member (MS) in a direction away from the rotating member (KT) when the electric motor (MTR) is not energized. The returning mechanism (MDK) is configured by a spiral spring (SPR) having a part (Pkc) of one end (Se1) locked on a rotating shaft (SFI, SFO) driven by the electric motor (MTR) and a housing (HSG) housing the spiral spring (SPR) and having a holding surface (Mks) extending in a radial outer direction (Drs) of the spiral spring (SPR) and formed thereon.

In the electrically operated brake device for a vehicle according to the present disclosure, a restraint section (Pks) is formed at a part of the other end (Se2) located on a side opposing the one end (Se1) of the spiral spring (SPR), and, when the electric motor (MTR) is rotated in a forward direction (Fwd) which is a direction for approximating the friction member (MS) to the rotating member (KT), the restraint section (Pks) presses the holding surface (Mks), and the spiral spring (SPR) is configured to give a returning torque (Tqr) in a reverse direction (Rvs) opposing the forward direction (Fwd) to the electric motor (MTR).

According to the configuration, since the restraint section Pks and the holding surface Mks are in substantially perpendicular contact with each other, the returning torque Tqr can be set as a sufficiently large value with a simple configuration.

Alternatively, in the electrically operated brake device for a vehicle according to the present disclosure, at the part of the other end (Se2) located on a side opposing the one end (Se1) of the spiral spring (SPR), in order from a side close to the one end (Se1), “a first valley-folded part (Pt1) valley-folded at a right angle in the longitudinal direction of the spiral spring (SPR) to an outer peripheral surface (Mst) of the spiral spring (SPR)”, “a first mountain-folded part (Py1) mountain-folded at a right angle in the longitudinal direction to the outer peripheral surface (Mst)”, and “a second mountain-folded part (Py2) mountain-folded at a right angle in the longitudinal direction to the outer peripheral surface (Mst)” are formed, when the electric motor (MTR) is rotated in the forward direction (Fwd) which is a direction for approximating the friction member (MS) to the rotating member (KT), the first mountain-folded part (Py1) presses the holding surface (Mks), and the spiral spring (SPR) is configured to give a returning torque (Tqr) in a reverse direction (Rvs) opposing the forward direction (Fwd) to the electric motor (MTR).

According to the above configuration, since a contact part to the holding surface Mks is formed by a folding process for the end of the spiral spring SPR, a returning mechanism MDK can be simplified. In addition, since a junction part (for example, junction by riveting or the like) between the restraint section Pks and the spiral spring SPR is omitted, the spiral spring SPR can be improved in strength as a whole.

### BRIEF DESCRIPTION OF DRAWINGS

FIG. 1 is an overall block diagram of an electrically operated brake device for a vehicle DDS according to the present disclosure.

FIG. 2 is a functional block diagram for explaining a process in a controller ECW.

FIG. 3 is a sectional view for explaining a returning mechanism MDK.

FIG. 4 is a sectional view for explaining a holding part Bsa of the returning mechanism MDK.

FIG. 5 is a characteristic chart for explaining a relationship between a rotating angle and a returning torque in the returning mechanism MDK.

FIG. 6 is a schematic diagram for explaining the details of a restraint section Pks.

FIG. 7 is a schematic diagram for explaining the details of a hooking section Pkc.

### DESCRIPTION OF EMBODIMENTS

### <Overall Configuration of Electrically Operated Brake Device for Vehicle According to the Present Disclosure>

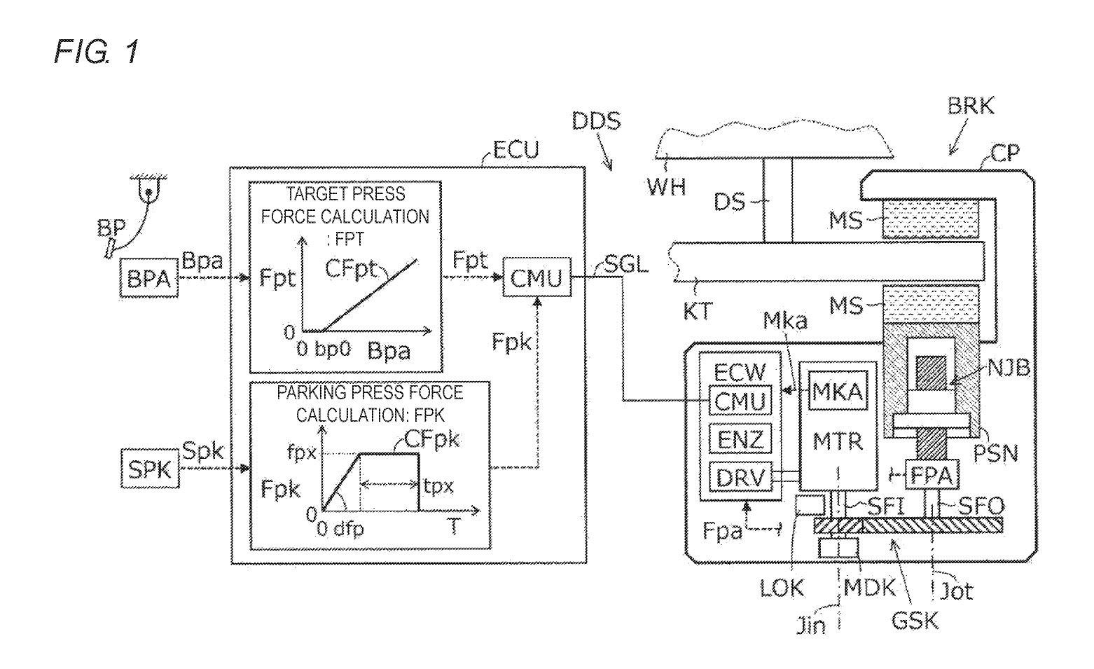

An electrically operated brake device DDS according to an embodiment of the present disclosure will be described below with reference to the overall block diagram in FIG. 1. In the following explanation, the constituent members, arithmetic processes, signals, characteristics, and values to which the same signs exert the same functions, respectively. Thus, redundant explanations may be omitted.

A vehicle including the electrically operated brake device DDS is equipped with a brake operation member BP, a manipulated variable sensor BPA, a switch SPK for a parking brake, a body-side controller ECU, a braking actuator BRK, and a communication line SGL. Furthermore, each wheel WH of the vehicle includes a brake caliper CP, a rotating member KT, and a friction member MS.

The brake operation member (for example, brake pedal) BP is a member operated by a driver to decelerate the vehicle. The brake operation member BP is operated to adjust a braking torque to the wheel WH to generate braking force for the wheel WH. More specifically, the rotating member KT is fixed to the wheel WH of the vehicle. The brake caliper CP is disposed to sandwich the rotating member (for example, brake disk) KT. In the brake caliper (also simply called a caliper) CP, two friction members (for example, brake pads) MS are pressed against the rotating member KT by motive energy of an electric motor MTR. Since the rotating member KT and the wheel WH are fixed to each other to rotate integrally with each other, frictional force generated at this time gives a braking torque to the wheel WH to generate braking force consequently.

The braking manipulated variable sensor BPA is disposed on the brake operation member (brake pedal) BP. The braking manipulated variable sensor BPA detects a manipulated variable (braking manipulated variable) Bpa of the brake operation member BP by the driver. As the braking manipulated variable sensor BPA, at least one of a sensor (pressure sensor) detecting a pressure of a master cylinder, a sensor (stepping force sensor) detecting operation force of the brake operation member BP, and a sensor (stroke sensor) detecting an operation displacement of the brake operation member BP is employed. Thus, the braking manipulated variable Bpa is determined on the basis of at least one of the master cylinder pressure, the brake pedal stepping force, and the brake pedal stroke. The braking manipulated variable Bpa is input to the body-side controller ECU.

A switch for a parking brake (also simply called a parking switch) SPK is disposed on an operation panel on the dashboard of the vehicle. The parking switch SPK is an ON/OFF switch. The parking switch SPK designates whether the driver requires the parking brake. When the parking brake is required, an on state is output as a signal (parking signal) Spk from the parking switch SPK. On the other hand, when no parking brake is required, an off state is output as the parking signal Spk.

### <<Body-Side Controller ECU>>

In the body of the vehicle, the body-side controller (also called a “body-side electronic control unit”) ECU is disposed. The body-side controller ECU includes an electric circuit including a microprocessor and fixed to the body. The body-side controller ECU is configured by a target press force calculating block FPT, a parking press force calculating block FPK, and a body-side communication unit CMU. The target press force calculating block FPT, the parking press force calculating block FPK, and the communication unit CMU are control algorithms which are programmed in the microprocessor of the body-side controller ECU.

In the target press force calculating block FPT, on the basis of the braking manipulated variable Bpa, a target press force (target value) Fpt is calculated. In this case, the target press force Fpt is a target value of force (press force) for causing the friction member MS to press the rotating member KT. The target press force Fpt is calculated on the basis of the braking manipulated variable Bpa and a preset calculation characteristic (calculation map) CFpt. In the calculation characteristic CFpt, the target press force Fpt is calculated to “0” when the braking manipulated variable Bpa ranges from “0” to a value bp0. When the manipulated variable Bpa exceeds the value bp0, the target press force Fpt is calculated according to an increase of the manipulated variable Bpa so as to monotoneously increase from “0”. In this case, the value bp0 is a preset predetermined value corresponding to an “allowance” (free moving between the constituent parts)” of the brake operation member BP, and is called an “allowance value”.

In the parking press force calculating block FPK, on the basis of the parking signal Spk, a parking press force (target value) Fpk is calculated. Like the target press force Fpt, the parking press force Fpk is a target value of force (press force) for causing the friction member MS to press the rotating member KT. The parking press force Fpk is calculated on the basis of the parking signal Spk and a preset time-series calculation characteristic (calculation map) CFpk. In the calculation characteristic CFpk, a timing at which the parking signal Spk changes from an off state to an on state is set to “0” at time T. More specifically, “T=0” is defined as a start point in the calculation characteristic CFpk. According to lapse of time T, the parking press force Fpk is increased from “0” to a value fpx by an increment (predetermined time inclination) dfp per unit time. In this case, the parking press force fpx is a preset predetermined value which is called “parking holding force”. In the calculation characteristic CFpk, after a state of “Fpk=fpx” is maintained for a predetermined time tpx (preset predetermined value), the parking press force Fpk is decreased to “0”. Before the parking press force Fpk is decreased toward “0”, since rotational movement of the electric motor MTR is restricted by a lock mechanism LOK, an actual press force Fpa is still kept at the parking press force fpx.

The target, parking press force Fpt, Fpk (target value of press force) are output to the communication unit CMU. The body-side communication unit CMU is connected to the communication line SGL exchanges (receives/transmits) a data signal with a wheel-side communication CMU of a wheel-side controller ECW. The body-side controller ECU has been described above.

### <<Braking Actuator BRK>>

The braking actuator BRK will be described below. The braking actuator (also simply called an “actuator”) BRK presses the friction member MS against the rotating member KT rotating together with the wheel. By frictional force generated at this time, the actuator BRK gives a braking torque to the wheel WH, generates braking force, and decelerates the traveling vehicle. As the actuator BRK, a configuration of a so-called floating disk brake (configuration employing a floating caliper) is exemplified.

The actuator BRK is configured by the brake caliper CP, a press piston PSN, the electric motor MTR, a rotating angle sensor MKA, a reducer GSK, an input shaft SFI, an output shaft SFO, a screw member NJB, a press force sensor FPA, the wheel-side controller ECW, the lock mechanism LOK, and the returning mechanism MDK.

The brake caliper (also simply called a caliper) CP is configured to sandwich a (brake disk) KT through the two friction members (brake pads) MS. In the caliper CP, the press piston (also simply called a “piston”) PSN is moved (forward or backward) with respect to the rotating member KT. With the displacement of the piston PSN, the friction members MS are pressed against the rotating member KT to generate frictional force. The displacement of the piston PSN is performed by motive energy of the electric motor MTR. More specifically, the input shaft SFI is fixed to the output shaft of the electric motor MTR, and the output shaft and the input shaft SFI rotate together with each other about a rotating axis line Jin. An output (rotating force around the shaft) of the electric motor MTR is input to the input shaft SFI.

The input shaft SFI is a rotating shaft member rotating around the rotating axis line Jin. A small-diameter gear is fixed to the input shaft SFI. The small-diameter gear is meshed with a large-diameter gear to constitute the reducer GSK. The output shaft SFO is fixed to the large-diameter gear. The output shaft SFO is a rotating shaft member rotating around a rotating axis line Jot. Motive energy of the electric motor MTR is transmitted from the input shaft SFI to the output shaft SFO through the reducer GSK. Rotating motive energy (torque motive energy) of the output shaft SFO is converted by the screw member NJB into linear motive energy (thrust force in the central axis direction of the piston PSN which is coaxial with the rotating axis line Jot). The screw member NJB and the piston PSN are fixed so as to be able to relatively move. For this reason, the rotating motive energy is transmitted to the piston PSN. As a result, the piston PSN moves with respect to the rotating member KT. By the displacement of the piston PSN, the friction member MS adjusts force (press force) pressing the rotating member KT. Since the rotating member KT is fixed to the wheel, frictional force is generated between the friction member MS and the rotating member KT to adjust braking force of the wheel.

The electric motor MTR is a motive energy source to drive (move) the piston PSN. For example, as the electric motor MTR, a brush motor is employed. In the rotating direction of the electric motor MTR, a forward direction Fwd corresponds to a direction (i.e., direction in which press force increases and a braking torque increases) in which the friction member MS approximates to the rotating member KT. In addition, a reverse direction Rvs of the electric motor MTR corresponds to a direction (i.e., direction in which press force decreases and a braking torque decreases) in which the friction member MS comes away from the rotating member KT. In the moving direction of the press piston PSN, a forward direction Fwd is a normal direction of the electric motor MTR, and corresponds to a direction in which press force Fpa increases. The backward direction of the piston PSN is a reverse direction Rvs of the electric motor MTR, and corresponds to a direction in which the press force Fpa decreases.

The rotating angle sensor MKA detects a position (i.e., rotating angle) Mka of the rotor (rotator) of the electric motor MTR. The detected rotating angle Mka is input to the wheel-side controller ECW. The press force sensor FPA detects force (actual press force) Fpa for causing the piston PSN to actually press the friction member MS. The detected actual press force (detection value of the press force) Fpa is input to the wheel-side controller ECW. For example, the press force sensor FPA is disposed between the output shaft SFO and the caliper CP.

The wheel-side controller ECW is an electric circuit driving the electric motor MTR. The wheel-side controller ECW, on the basis of the target, parking press force Fpt, Fpk, drives the electric motor MTR and controls an output (rotating speed and torque) therefrom. In this case, the target, parking press force Fpt, Fpk are transmitted from the body-side controller ECU to the wheel-side controller ECW through the communication line (also called a “signal line”) SGL. The wheel-side controller ECW (also called a “wheel-side electronic control unit”) is disposed (fixed) in the caliper CP. The wheel-side controller ECW is configured by the communication unit CMU, a calculation unit ENZ, and a drive unit DRV

The wheel-side communication unit CMU is connected to the communication line SGL, and exchanges a data signal with the body-side communication unit CMU of the body-side controller ECU. In the calculation unit ENZ, drive signals Sw1 to Sw4 controlling switching elements SW1 to SW4 to drive the electric motor MTR are calculated. The drive unit (drive circuit) DRV is configured as a bridge circuit BRG configured by the four switching elements SW1 to SW4. In the bridge circuit BRG, on the basis of the drive signals Sw1 to Sw4, the energization states of the switching elements SW1 to SW4 are switched. With the switching, the electric motor MTR is rotationally driven, and an output from the electric motor MTR is adjusted.

The parking brake lock mechanism LOK is disposed on the input shaft SFI. When the lock mechanism LOK requires a parking brake, even though energization to the electric motor MTR is stopped, a press contact between the friction member MS and the rotating member KT is maintained (i.e., the press force Fpa is kept at the parking press force fpx). The lock mechanism LOK, for example, as described in JP 2014-109315 A, is configured by a ratchet gear and a ratchet pawl.

The returning mechanism MDK is disposed on the input shaft SFI (corresponding to a “rotating shaft”). When the energization to the electric motor MTR is stopped by the returning mechanism MDK, the press contact between the friction member MS and the rotating member KT is canceled (i.e., the actual press force Fpa is set to “0”). More specifically, when the electric motor MTR is driven in the forward direction Fwd, elastic energy is accumulated in the returning mechanism MDK. With the elastic energy, in a non-energization state of the electric motor MTR, the electric motor MTR is rotated in the reverse direction Rvs. As a result, the piston PSN is moved in the backward direction, and the friction member MS is moved in a direction in which the friction member MS comes away from the rotating member KT. For this reason, even though power supply to the electric motor MTR is not performed, a press state between the friction member MS and the rotating member KT can be canceled by the returning mechanism MDK. The braking actuator BRK has been described above.

The communication line SGL is disposed as a communication means between the body-side controller ECU and the wheel-side controller ECW. The communication line SGL transmits (receives/transmits) a data signal between the body-side controller ECU and the wheel-side controller ECW. A serial communication bus is employed as the communication line SGL.

### <Process in Controller ECW>

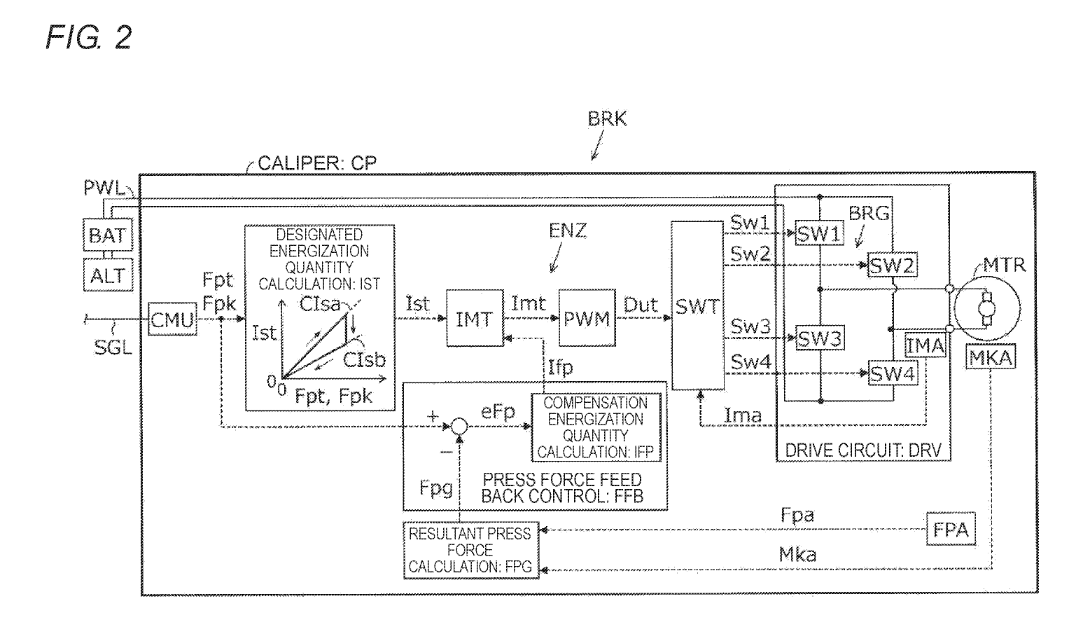

A process in the wheel-side controller ECW will be described below with reference to the functional block diagram in FIG. 2.

The wheel-side controller ECW, on the basis of the target press force Fpt and the parking press force Fpk received from the body-side controller ECU, adjusts a state of energizing the electric motor MTR (finally, the magnetization and direction of a current) to control the output and rotating direction of the electric motor MTR. The wheel-side controller ECW is configured by the communication unit CMU, the calculation unit ENZ, and the drive unit (drive circuit) DRV.

The wheel-side communication unit CMU is connected to the body-side communication unit CMU of the body-side controller ECU through the communication line SGL. Through the communication line SGL (for example, serial communication bus), the target, parking press force Fpt, Fpk are sent (transmitted) from the body-side controller ECU to the wheel-side controller ECW.

The calculation unit ENZ is a control algorithm which is programmed in the microprocessor in the wheel-side controller ECW. The calculation unit ENZ is configured by a designation energization quantity calculation block IST, a resultant press force calculation block FPG, a press force feedback control block FFB, a target energization quantity calculation block IMT, a pulse width modulation block PWM, a switching control block SWT, and a suitability determination block TKH.

In the designation energization quantity calculation block IST, on the basis of the target, parking press force Fpt, Fpk and preset calculation characteristics (calculation map) Clsa, Clsb, a designation energization quantity Ist is calculated. The designation energization quantity Ist is a target value of an energization quantity to the electric motor MTR to achieve target, parking press force Fpt, Fpk. The calculation map of the designation energization quantity Ist is configured by the two calculation characteristics Clsa, Clsb in consideration of the hysteresis of the actuator BRK.

The “energization quantity” is a state quantity (variable) to control an output torque of the electric motor MTR. Since the electric motor MTR outputs a torque generally proportional to a current, a current target value of the electric motor MTR can be used as the target value of the energization quantity. In addition, when a supply voltage to the electric motor MTR increases, since a current is increased consequently, a supply voltage value can be used as a target energization quantity.

In the resultant press force calculation block FPG, on the basis of the actual press force Fpa and rotating angle Mka, a resultant press force Fpg. When the actual press force Fpa is small, since the resolution of the actual press force Fpa is low, on the basis of the rotating angle Mka, the actual press force Fpa can be complemented. More specifically, as described in JP 2014-177204 A, on the basis of “estimated press force Fpe calculated on the basis of the actual press force Fpa and the rotating angle Mka” and “each contribution ratio”, the resultant press force Fpg is determined. The contribution ratio of the actual press force Fpa is set to be high as the actual press force Fpa is large. In contrast to this, the contribution ratio of the estimated press force Fpe is set to be low as the actual press force Fpa is large.

In the press force feedback control block FFB, on the basis of the target, parking press force (target value) Fpt, Fkp and the resultant press force Fpg, a compensation energization quantity Ifp is calculated. More specifically, first, a deviation (press force deviation) eFp between the target, parking press force Fpt, Fpk and the resultant press force Fpg is calculated. In a compensation energization quantity calculation block IFP, by PID control based on the press force deviation eFp, the compensation energization quantity Ifp is calculated. Although the designation energization quantity Ist is calculated as a value corresponding to the target, parking press force Fpt, Fpk, an efficiency change of the actuator BRK may generate an error between the target, parking press force Fpt, Fpk and the actual press force (detection value) Fpa. Therefore, the compensation energization quantity Ifp is determined such that the error decreases. More specifically, the resultant value Fpg based on the actual value Fpa (detection value of the press force sensor FPA) of press force is controlled to be equal to the target, parking press force Fpt, Fpk of the press force.

In the target energization quantity calculation block IMT, a target energization quantity Imt which is a final target value to the electric motor MTR is calculated. In the target energization quantity calculation block IMT, the designation energization quantity Ist is adjusted by the compensation energization quantity Ifp, and the target energization quantity Imt is calculated. More specifically, the compensation energization quantity Ifp is added to the designation energization quantity Ist to calculate the target energization quantity Imt. On the basis of the sign (positive or negative of the value) of the target energization quantity Imt, a rotating direction of the electric motor MTR is determined, and an output (rotating motive energy) of the electric motor MTR is controlled on the basis of the magnitude of the target energization quantity Imt. For example, when the target energization quantity Imt is positive (Imt>0), the electric motor MTR is driven in the forward direction (increasing direction of press force) Fwd. When the target energization quantity Imt is negative (Imt<0), the electric motor MTR is driven in the reverse direction (decreasing direction of press force) Rvs. In addition, an output torque of the electric motor MTR is controlled to increase as the absolute value of the target energization quantity Imt is large, and the output torque is controlled to decrease as the absolute value of the target energization quantity Imt is small.

In the pulse width modulation block PWM, on the basis of the target energization quantity Imt, a designation value (target value) to perform pulse width modulation is calculated. More specifically, in the pulse width modulation block PWM, on the basis of the target energization quantity Imt and a preset characteristic (calculation map), a duty ratio Dut (in a periodic pulse wave, a ratio of a pulse width in an on state corresponding to the period) of a pulse width is determined. In addition, in the pulse width modulation block PWM, on the basis of the sign (positive sign or negative sign) of the target energization quantity Imt, the rotating direction of the electric motor MTR is determined. For example, the rotating direction of the electric motor MTR is set such that the forward direction Fwd is a positive (plus) value and the reverse direction Rvs is a negative (minus) value. Since a final output voltage is determined by an input voltage (power supply voltage) and the duty ratio Dut, in the pulse width modulation block PWM, the rotating direction of the electric motor MTR and an energization quantity to the electric motor MTR (i.e., output of the electric motor MTR) are determined.

Furthermore, in the pulse width modulation block PWM, so-called current feedback control is executed. In this case, a detection value (for example, an actual current value) Ima of an energization quantity sensor IMA is input to the pulse width modulation block PWM. On the basis of a deviation elm between the target energization quantity Imt and an actual energization quantity (detection value of the current sensor IMA) Ima, the duty ratio Dut is corrected (finely adjusted) such that the deviation elm approximate to “0”. The current feedback control can achieve accurate motor control.

The switching control block SWT outputs, on the basis of the duty ratio (target value) Dut, the drive signals Sw1 to Sw4 to the switching elements SW1 to SW4 constituting the bridge circuit BRG. The drive signals Sw1 to Sw4 designate whether the switching elements are set in “an energization state or a non-energization state”. When the duty ratio Dut is high, an energization time per unit time is elongated, and a larger current is caused to flow in the electric motor MTR.

The drive unit DRV is an electric circuit to drive the electric motor MTR. The drive unit DRV is configured by the bridge circuit BRG and energization quantity sensor (current sensor) IMA. In this case, the drive unit DRV used when a brush motor (also simply called a “brush motor”) is employed as the electric motor MTR.

The bridge circuit BRG is configured by the switching elements SW1 to SW4. The switching elements SW1 to SW4 are elements which can turn on (energize) or off (non-energize) a part of the electric circuit. The switching elements SW1 to SW4 are driven by the drive signals Sw1 to Sw4 from the calculation unit ENZ. The energization/non-energization state of each of the switching elements is switched to adjust the rotating direction and the output torque of the electric motor MTR. For example, as the switching elements SW1 to SW4, MOS-FETs or IGBTs are used.

In the bridge circuit BRG, the energization quantity sensor IMA is disposed to detect the energization quantity (actual value) Ima of the electric motor MTR. For example, as the energization quantity sensor IMA, the current sensor IMA is employed. A current value actually flowing in the electric motor MTR can be detected as an actual energization quantity Ima. The rotating angle sensor MKA is disposed on the electric motor MTR to acquire (detect) a rotating angle (actual value) Mka of the rotor. The detection value Mka of the rotating angle is input to the wheel-side controller ECW.

The press force sensor FPA detects the force (press force) Fpa for causing the piston PSN to press the friction member MS. More specifically, the press force sensor FPA detects force for causing the rotating member KT to press the friction member MS. The press force sensor FPA is disposed between the screw member NJB and the caliper CP. For example, the press force sensor FPA is fixed to the caliper CP to detect reaction force (reaction) which receives from the friction member MS to the piston PSN as the press force Fpa. The detection value Fpa of the press force is input to the wheel-side controller ECW.

A power supply for the electric motor MTR is configured by a battery BAT and an alternator ALT. The battery BAT and the alternator ALT are disposed on the body side of the vehicle. The power source ALT, BAT supplies electric power to the body-side controller ECU and the wheel-side controller ECW through a power line PWL. As a result, electric power to the electric motor MTR is supplied by the battery BAT or the like.

### <Returning Mechanism MDK>

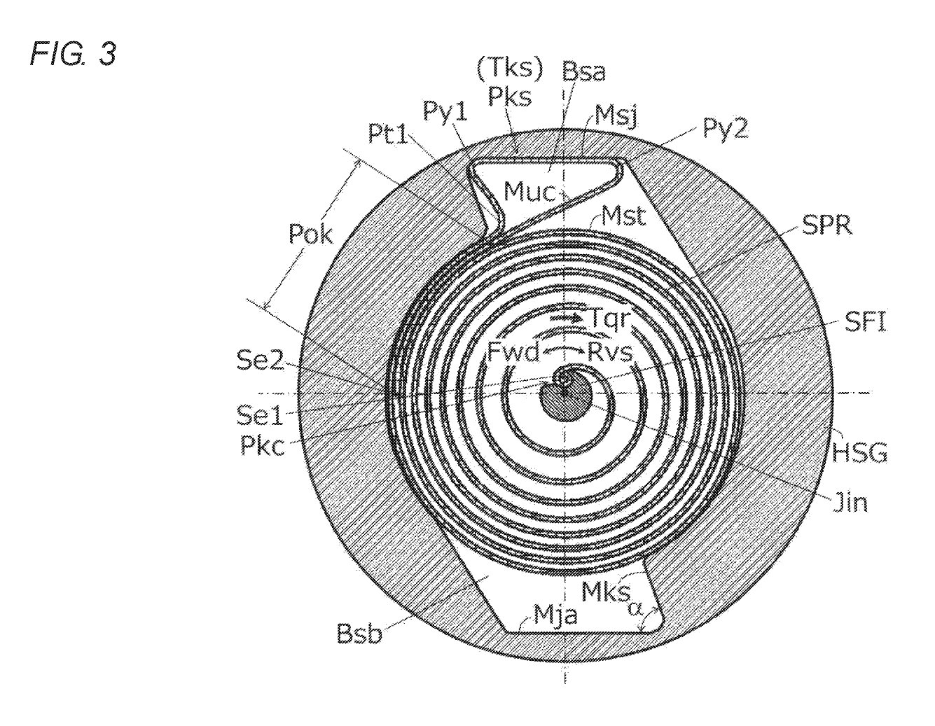

An example of the returning mechanism MDK will be described with reference to the sectional view in FIG. 3. The returning mechanism MDK gives a torque to rotate the electric motor MTR in a direction Rvs (backward direction of the piston PSN and the reverse direction of the electric motor MTR) causing the friction member (brake pad) MS to come away from the rotating member (brake disk) KT. The torque is a “returning torque Tqr”. When the returning torque Tqr stops the energization to the electric motor MTR, the piston PSN is returned to at least an initial position. In this case, the initial position of the piston PSN corresponds to a position at which a gap between the rotating member KT and the friction member MS is almost zero and the press state therebetween is released for the first time when the friction member MS comes away from the rotating member KT.

The operation of returning the piston PSN to the initial position is necessary even if power supply to the electrically operated brake device DDS is stopped as a failsafe function. Thus, the returning of the piston PSN to the initial position is achieved by elastic energy accumulated in the returning mechanism MDK. Furthermore, the initial position of the piston PSN changes by friction of the friction member MS. More specifically, when a wear amount of the friction member MS increases, the initial position of the piston PSN sequentially moves in a forward direction (direction approximating to the rotating member KT, corresponding to the forward direction Fwd of the electric motor MTR). Regardless of the wear amount of the friction member MS, the returning mechanism MDK requires a wear compensation mechanism such that accumulated elastic energy of the returning mechanism MDK is held almost constant.

The returning mechanism MDK is disposed on the input shaft SFI (corresponding to “rotating shaft”). The input shaft SFI is fixed to the electric motor MTR to be rotated together with the output shaft of the electric motor MTR. The returning mechanism MDK is configured by the spiral spring (elastic body) SPR and a housing HSG. The spiral spring SPR is a mechanical element obtained by spirally winding a highly elastic belt-like material. In the spiral spring SPR, force (elastic force) for returning the winding state to an original state is used. The spiral spring is also called a “power spring”. In addition, the housing HSG is a member storing the spiral spring SPR. In the housing HSG, a dent (concave part) is formed to store the spiral spring SPR. An end of the spiral spring SPR is locked on an end face (wall of the dent) Mks of the concave part, and the spiral spring SPR functions as a spring (i.e., elastic force Fsp is generated).

On one end (also called an “internal end”) Se1 of the spiral spring SPR, the hooking section Pkc is formed, and the input shaft SFI is fixed. For example, in the spiral shape of the spiral spring SPR, the hooking section Pkc is formed such that the internal end Se1 (part close to the end) is bent to be inward rounded. In other words, the hooking section Pkc is shaped such that a part of the one end Se1 is winded to be mountain-folded (i.e., valley-folded with respect to an inner peripheral surface Muc) with respect to an outer peripheral surface Mst of the spiral spring SPR. The shape of the hooking section Pkc is an almost cylindrical shape. On the outer peripheral part of the input shaft SFI, a cutout part having a semi-circular section is formed such that the hooking section Pkc of the spiral spring SPR is hooked (fixed by hooking) on the outer peripheral part. Thus, the spiral spring SPR is fixed such that the cutout part of the input shaft SFI and the hooking section Pkc having a cylindrical shape are meshed with each other with directionality. In a state (i.e., when “Tqr=0”) in which the spiral spring SPR is not winded, the hooking section Pkc is gotten into (fitted into) the cutout part of the input shaft SFI. When the input shaft SFI is rotated in the reverse direction Rvs in this state, the hooking section Pkc moves out of the cutout part. Thus, the input shaft SFI is idly rotated with respect to the hooking section Pkc.

When the input shaft SFI is rotated by the electric motor MTR in the forward direction Fwd, the hooking section Pkc of the one end Se1 is hooked on the cutout part of the input shaft SFI. That is, the hooking section Pkc which is simply fitted in the cutout part is fixed by receiving force from the cutout part. For this reason, with rotation of the input shaft SFI, the spiral spring SPR is sequentially winded. On the other hand, when the input shaft SFI is rotated in the reverse direction Rvs in a state in which the spiral spring SPR is not winded at all, the hooking section Pkc is not hooked on the cutout part of the input shaft SFI. More specifically, when the spiral spring SPR is not winded, the hooking section Pkc and the cutout part have directionality such that “the hooking section Pkc and the cutout part are locked in the forward direction Fwd but not locked in the reverse direction Rvs”.

In the longitudinal direction of the belt-like spiral spring SPR, at a part of the other end (also called an “external end”) Se2 (part close to the other end) located on the opposite side of the internal end Se1, a restraint section Pks is formed. The restraint section Pks, at the part of the external end Se2, is a part to restrain relative motion to the housing HSG. For example, the restraint section Pks is formed to be bent two or more times at a right angle (i.e., in parallel with the rotating axis line Jin of the input shaft SFI) with respect to the longitudinal direction of the spiral spring SPR. More specifically, in the spiral columnar shape of the spiral spring SPR, a fold line of the bent part is along the generating line of the column. More specifically, the restraint section Pks is formed to be valley-folded (called a “first valley-folded part Pt1”), mountain-folded (called a “first mountain-folded part Py1”), and mountain-folded (called a “second mountain-folded part Py2”) with respect to the outer peripheral surface Mst in order from a side close to the internal end Se1 (in order from a side far from the external end Se2). In this case, a triangle Pt1-Py1-Py2 having the bent parts as apexes is called a “restraint triangle Tks”. In the spiral spring SPR, in order to stably form the restraint triangle Tks, a part (called a “nipped part Pok”) closer to the other end Se2 than the first mountain-folded part Py1 is configured to be sandwiched by the outer peripheral surface Mst of the spiral spring SPR and the inner peripheral surface Muc (rear side of the outer peripheral surface Mst).

The housing HSG is a member which has bottomed concave parts Bsa, Bsb, and Bsp and store the spiral spring SPR. In this case, the concave parts (first and second holding parts) Bsa and Bsb are to restrain the restraint section Pks, and the concave part (storing part) Bsp is to store the spiral spring SPR. In the bottom part (especially, the bottom part of the concave part Bsp) of the housing HSG, a through hole for the input shaft SFI is formed. The input shaft SFI locked on the distal end of the output shaft of the electric motor MTR is supported by a bush and penetrates the through hole formed in the bottom of the concave part Bsp. More specifically, the input shaft SFI is mounted such that the input shaft SFI can be rotated with respect to the housing HSG. In the housing HSG, the input shaft SFI, the cutout part is formed. The distal end of the input shaft SFI is supported by the bush. The concave parts Bsa, Bsb, and Bsp are closed (lidded) with closing members to form a space for storing the spiral spring SPR.

The first and second holding parts Bsa and Bsb of the housing HSG are located in a radial outer direction Drs having the rotating axis line Jin of the input shaft SFI as the center with respect to the storing part Bsp and are disposed in series with the storing part Bsp. Since the spiral spring SPR is obtained by spirally winding a highly elastic material, the spiral spring SPR tends to expand outside. Thus, the restraint section Pks (i.e., the restraint triangle Pt1-Py1-Py2) is normally stored in the first and second holding parts Bsa and Bsb. For example, when the spiral spring SPR is not winded (i.e., when “Tqr=0”), the restraint section Pks is gotten into (fitted in) the first and second holding parts Bsa and Bsb.

Inside the first and second holding parts Bsa and Bsb of the housing HSG, a plane (called the “holding surface Mks”) extending in parallel with the rotating axis line Jin and from the rotating axis line Jin in the radial outer direction Drs. The holding surface Mks is in series with an inner peripheral surface Msp (almost cylindrical surface parallel with the rotating axis line Jin) of the storing part Bsp. Thus, the first and second holding parts Bsa and Bsb and the storing part Bsp form one space. When the input shaft SFI is rotated in the forward direction Fwd by the electric motor MTR, the first mountain-folded part Py1 of the restraint section Pks is pressed against the holding surface Mks. That is, the restraint section Pks which is simply fitted in the first and second holding parts (concave parts) Bsa and Bsb receives force from the holding surface Mks and fixed (locked). More specifically, the first mountain-folded part Py1 of the restraint section Pks is pressed against the holding surface Mks at an almost right angle to restrain the motion in the forward direction Fwd. As a result, with the rotation of the input shaft SFI, the spiral spring SPR is winded, and the returning torque Tqr is increased.

As described above, when the electric motor MTR (consequently, the input shaft SFI) is driven in the forward direction Fwd, the part (i.e., the hooking section Pkc) of the internal end Se1 is locked on (fixed to) an outer peripheral cutout part of the input shaft SFI. The part of the external end Se2 (i.e., the restraint section Pks) is locked by being pressed against the holding surface Mks of the first and second holding parts Bsa and Bsb. When the spiral spring SPR is sequentially tightly winded, the elastic energy accumulated in the spiral spring SPR increases, and the spiral spring SPR gives the returning torque Tqr to the input shaft SFI such that the input shaft SFI is rotated in the reverse direction Rvs. The returning torque in the reverse direction Rvs is generated by elastic force Fsp (return spring force). Even though the electric motor MTR is not energized by the returning torque Tqr, the friction member MS can be moved in a direction (backward direction) away from the rotating member KT.

As will be described in detail, in the holding parts Bsa and Bsb, a pressure receiving surface Mja having an angle of 50 to 100 degrees with respect to the holding surface Mks is formed. An angle between the holding surface Mks and the pressure receiving surface Mja is called a “holding surface angle α”. The restraint section Pks is being in contact with the holding surface Mks at the first mountain-folded part Py1. In other words, the spiral spring SPR, at the first mountain-folded part Py1, receives the elastic force Fsp in a tangential direction (direction parallel with a tangent line surface Mss (will be described later)) from the holding surface Mks. In order to suppress the first valley-folded part Pt1 from being deformed and to avoid local force from being concentrated, the elastic force Fsp is supported by contact force (area contact) between a press surface Msj (the outer peripheral surface Mst between the first mountain-folded part Py1 and the second mountain-folded part Py2) and the pressure receiving surface Mja.

### <Holding Part Bsa of Returning Mechanism MDK>

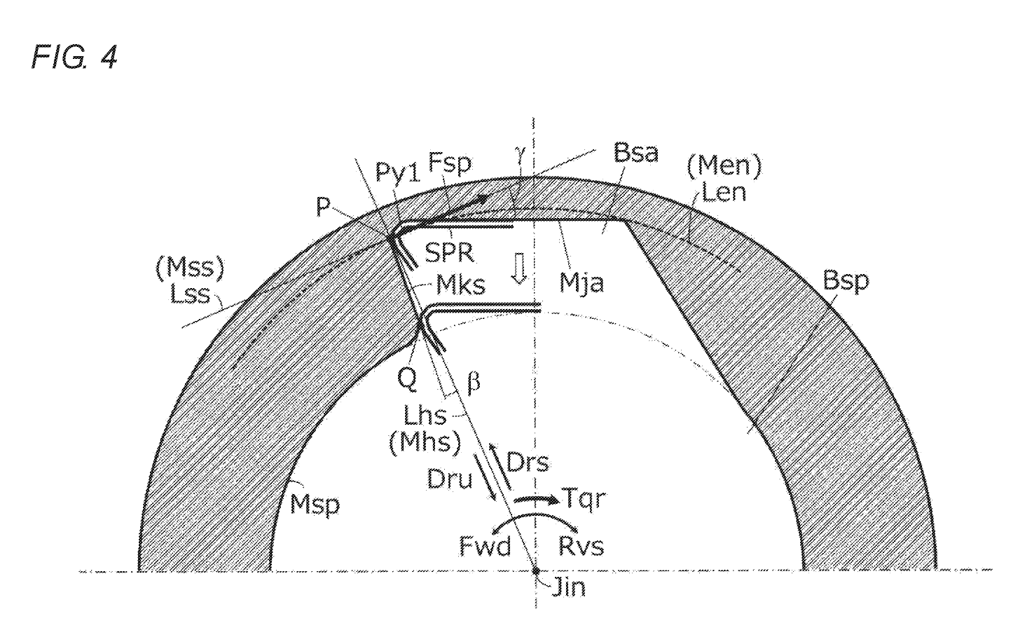

The details of the holding part Bsa of the returning mechanism MDK will be described below with reference to the sectional view in FIG. 4. The second holding part Bsb of the returning mechanism MDK and the first holding part Bsa, in the sectional view, are point symmetric with respect to a rotating axis line Jin (figures are matched with each other when one of the figures is rotated at 180 degrees about the rotating axis line Jin).

Before the geometric shape, arrangement, and the like of the holding part Bsa are described, in a sectional surface vertical to the rotating axis line Jin of the input shaft SFI, each line will be defined. When the restraint section Pks maximally expands in the holding part Bsa (when the press surface Msj is in area contact with the pressure receiving surface Mja), at a point P, the restraint section Pks (in particular, the first mountain-folded part Py1) is in contact with the holding surface Mks. A straight line connecting the rotating axis line Jin and the point P (contact part between the restraint section Pks and the holding surface Mks) is called a “normal line Lhs”. An arc having the rotating axis line Jin as the center and passing through the point P is called an “arc Len”. A straight line passing through the point P and vertical to the normal line Lhs (i.e., a tangent line of the arc Len at the point P) is called a “tangent line Lss”. The tangent line Lss is also a line crossing a “circle Len having the rotating axis line Jin as the center and passing through the point P (contact part between the restraint section Pks and the holding surface Mks) at one point. The normal line Lhs is vertical to the tangent line Lss.

Each surface of the interior (inner side) of the holding part Bsa will be defined next. Each surface of the interior of the holding part Bsa is in series with the inner peripheral surface Msp (cylindrical surface parallel with the rotating axis line Jin) in the storing part Bsp to form one space (chamber) storing the spiral spring SPR. A plane including the rotating axis line Jin and the normal line Lhs is called a “normal line surface Mhs”. In other words, the normal line surface Mhs is formed by the normal line Lhs along the rotating axis line Jin (is an aggregation of the normal lines Lhs). The normal line surface Mhs includes a contact part (i.e., a plane passing through the point P and being in parallel with the rotating axis line Jin) between the restraint section Pks and the holding surface Mks and the rotating axis line Jin. A curved surface being in parallel with the rotating axis line Jin and including the arc Len is called a “cylindrical surface Men (as in the above description, an aggregation of the arcs Len along the rotating axis line Jin)”. A plane being in parallel with the rotating axis line Jin and including the tangent line Lss is called a “tangent line surface Mss (as in the above description, an aggregation of the tangent lines Lss along the rotating axis line Jin)”. The tangent line surface Mss is a plane which passes through the point P (first mountain-folded part Py1) which is the contact part between the restraint section Pks and the holding surface Mks and is formed by the tangent line Lss of the arc Len having the rotating axis line Jin as the center. Note that the normal line surface Mhs and the tangent line surface Mss are vertical to each other.

The spiral spring SPR has a cylindrical spiral shape having the rotating axis line Jin as the center. In the returning mechanism MDK, the longitudinal direction of the spiral spring SPR is vertical (perpendicular) to the rotating axis line Jin. At the external (other end) Se2 of the spiral spring SPR, the restraint section Pks having the shape of the restraint triangle Tks is formed. Thus, the sectional shape (part except for the restraint section Pks) of the spiral spring SPR has a circular spiral shape. In the circular shape, the radial outer direction Drs is a direction away from the rotating axis line Jin (center). For example, the radial outer direction Drs is a direction starting from the rotating axis line Jin toward the point P along the normal line Lhs (i.e., the normal line surface Mhs). On the other hand, the radial inner direction Dru is a direction approximating to the rotating axis line Jin (center). On the other hand, the direction is a direction starting from the point P toward the rotating axis line Jin along the normal line Lhs (i.e., the normal line surface Mhs). The radial inner direction Dru is a direction opposing the radial outer direction Drs.

On the sectional surface of the dent (concave part) of the housing HSG, an inside of a circle (indicated by a chain double-dashed line) having the rotating axis line Jin as the center is the storing part Bsp. The storing part Bsp is a dent having an almost cylindrical inner wall (circumferential surface) Msp, and stores the spiral spring SPR (cylindrical spiral part of the spiral spring SPR except for the restraint section Pks) therein. The holding part Bsa, in the sectional view of the concave part, is a dent located outside (i.e., outside the circular indicated by the chain double-dashed line) the storing part Bsp. Inside the holding part Bsa, the holding surface Mks and the pressure receiving surface Mja are formed, and the restraint section Pks of the spiral spring SPR is stored. More specifically, the holding part Bsa includes the restraint triangle Tks. When the restraint section Pks (in particular, the first mountain-folded part Py1) is brought into contact with the holding surface Mks (i.e., contact by pressing) to restrain the motion (in particular, rotation in the forward direction Fwd) around the rotating axis line Jin of the spiral spring SPR so as to lock the part of the external end Se2. The inner peripheral surface Msp, holding surface Mks, and the pressure receiving surface Mja are continuous surfaces. These surfaces form one space.

The holding surface Mks serving as one of the inner walls of the holding part Bsa passes through a contact part (first mountain-folded part Py1) between the restraint section Pks and the holding surface Mks and extends from the rotating axis line Jin of the input shaft SFI to the radial outer direction Drs. When the input shaft SFI is rotated in the forward direction Fwd together with the electric motor MTR, the spiral spring SPR itself is rotated in the forward direction Fwd. However, since the holding surface Mks locks the rotation of the spiral spring SPR, the spiral spring SPR is tightly winded to generate the elastic force Fsp. The spiral spring SPR, at the contact part (point P of the first mountain-folded part Py1) between the restraint section Pks and the holding surface Mks, receives force Fsp in the tangent line Lss (i.e., tangent line surface Mss) direction from the holding surface Mks. Since the holding surface Mks is a surface (i.e., the normal line surface Mhs) extending in the radial outer direction Drs, the first mountain-folded part Py1 of the restraint section Pks is almost perpendicularly pressed against the holding surface Mks. For this reason, the large returning torque Tqr can be obtained with a simple configuration.

When the input shaft SFI is rotated in the forward direction Fwd to wind up the spiral spring SPR, a gap between the inner peripheral surface Muc and the outer peripheral surface Mst decreases, and the inner peripheral surface Muc and the outer peripheral surface Mst gradually come close to each other. With this tightly winding, the spiral spring SPR tends to be decreased in diameter. For this reason, the restraint section Pks is dragged in a direction to the rotating axis line Jin (which is the radial inner direction Dru and is indicated by a white arrow). The tightly winding state of the spiral spring SPR reaches a predetermined state (i.e., the returning torque Tqr reaches an upper limit torque tq2 (will be described later)), the restraint section Pks begins to slide on the holding surface Mks in the radial inner direction Dru and instantaneously slips out of the holding surface Mks. The displacement of the restraint section Pks in the radial inner direction Dru is blocked by static friction force. Force of the spiral spring SPR dragging the restraint section Pks in the radial inner direction Dru exceeds the static friction force, the restraint section Pks is immediately moved from the point P to a point Q. This is because a static friction coefficient (consequently, static friction force) is larger than a dynamic friction coefficient (consequently, dynamic frictional force). Since the torque limiter function is achieved by using an effect of reducing the diameter of the spiral spring SPR, even though the returning torque Tqr is made large by the above configuration (holding surface Mks almost matched with the normal line surface Mhs), the upper limit torque tq2 can be preferably set.

When the holding surface Mks comes close to the inside of the housing HSG from the outside thereof (in the radial inner direction Dru), the holding surface Mks can be formed to be slightly inclined in the forward direction Fwd with respect to the normal line surface Mhs (in the drawing, the normal line surface Mhs is inclined in a clockwise direction around point P). In other words, the holding surface Mks and the normal line surface Mhs cross each other on a straight line (contact part between the restraint section Pks and the holding surface Mks) including the point P, and the holding surface Mks is formed such that a distance between the holding surface Mks and the normal line surface Mhs increases when the holding surface Mks and the normal line surface Mhs approximate to the rotating axis line Jin. In this case, an angle between the holding surface Mks and the normal line surface Mhs is called “angle of slide β”. When the holding surface Mks and the normal line surface Mhs approximate from the point P to the rotating axis line Jin with the angle of slide β, since the elastic energy of the spiral spring SPR decreases, the spring becomes close to stable state of the spring. For this reason, the contact part Py1 can smoothly move.

The point Q illustrates a state in which the restraint section Pks reaches the internal end part (as a matter of fact, a part approximating the rotating axis line Jin) of the holding surface Mks. Over this state, when the spiral spring SPR is tightly winded (i.e., the returning torque Tqr is further increased), the restraint section Pks slips out of the holding surface Mks (is not in contact with the holding surface Mks) and slides on the inner peripheral surface Msp (cylindrical-shaped surface parallel with the rotating axis line Jin, and the inner wall of the inner peripheral surface Msp) of the storing part Bsp. When the tightly winding state of the spiral spring SPR is higher than a predetermined state (as will be described later, when “Tqr>tq2”), when the contact state of the restraint section Pks and the holding surface Mks is canceled, the spiral spring SPR is not needlessly tightly winded, the maximum value of the elastic energy accumulated in the spiral spring SPR is held almost constant. In this case, the returning torque Tqr at a point of time at which the contact state between the restraint section Pks and the holding surface Mks is canceled is called the “upper limit torque tq2”. The upper limit torque tq2 is mechanically set in advance on the basis of the spring characteristics of the spiral spring SPR, the spring shape (length, plate thickness, and the like), and the shape of the housing HSG (in particular, the holding parts Bsa and Bsb).

Since the spiral spring SPR tends to extend in the radial outer direction Drs, the restraint section Pks slides over 180 degrees and then is stored in the second holding part Bsb. The restraint section Pks (in particular, the first mountain-folded part Py1) is brought into contact with the holding surface Mks of the second holding part Bsb again, and the restraint section Pks is pressed by the holding surface Mks to lock (restrain) the external end Se2. An operation in which the restraint section Pks slips out of the holding surface Mks of the first holding part Bsa and locked on the holding surface Mks of the second holding part Bsb again is called a “re-locking operation”. By the re-locking operation, the maximum elastic energy accumulated in the returning mechanism MDK is held almost constant. More specifically, the re-locking operation functions as a torque limiter, and wear compensation of the friction member MS can be achieved.

In the holding part Bsa, the pressure receiving surface Mja (like the holding surface Mks, one of the inner walls of the holding part Bsa) can be formed to be inclined with respect to the tangent line surface Mss in the direction Dru approximating the rotating axis line Jin. In other words, around a straight line including the point P which is the contact part between the first mountain-folded part Py1 and the holding surface Mks, the tangent line surface Mss (right-side part from the point P in the drawing) which is one of the inner walls of the holding part Bsa is inclined in the radial inner direction Dru (clockwise direction in the drawing), and the pressure receiving surface Mja which is one of the inner walls of the holding part Bsa is formed in parallel with the tangent line surface Mss. An angle between the tangent line surface Mss and the pressure receiving surface Mja is called a “pressure receiving angle γ”.

The restraint section Pks of the spiral spring SPR receives the elastic force (returning spring force) Fsp along the tangent line surface Mss at the point P from the holding surface Mks of the housing HSG. The elastic force Fsp acts in the direction of the tangent line surface Mss, and a moment is generated such that the folded first valley-folded part Pt1 is stretched to transform the restraint triangle Tks.

The moment generated by the elastic force Fsp is supported by area contact between the press surface Msj of the restraint section Pks and the pressure receiving surface Mja. For this reason, the restraint triangle Tks is suppressed from being deformed, and local force does not act to disperse supporting force. When the pressure receiving surface Mja is inclined to the tangent line surface Mss by the pressure receiving angle γ in the radial inner direction Dru, component force of the elastic force Fsp acts in the radial outer direction Drs to press the restraint section Pks against the pressure receiving surface Mja. For this reason, the contact between the press surface Msj and the pressure receiving surface Mja is reliably achieved. Furthermore, since the restraint section Pks is held by the pressure receiving angle γ to extend in the radial outer direction Drs, even though vibration or the like from a road surface is input to the actuator BRK, the locking of the restraint section Pks can be reliably maintained. The press surface Msj, in the restraint triangle Tks, corresponds to the outer peripheral surface Mst between the first mountain-folded part Py1 and the second mountain-folded part Py2.

According to the correlation between the angle of slide β and the pressure receiving angle γ, an angle (holding surface angle) a between the holding surface Mks and the pressure receiving surface Mja preferably falls within the range of 50 to 100 degrees. When the holding surface angle α is set within the range, smooth slide movement (suppression of a stick slip) of the restraint section Pks on the holding surface Mks, suppression of deformation of the restraint triangle Tks, and dispersion of force (avoidance of stress concentration) can be achieved. Note that, due to the characteristic of the friction coefficient, the holding surface Mks is preferably made of a resin material.

### <Relationship Between Rotating Angle and Torque in Returning Mechanism MDK>

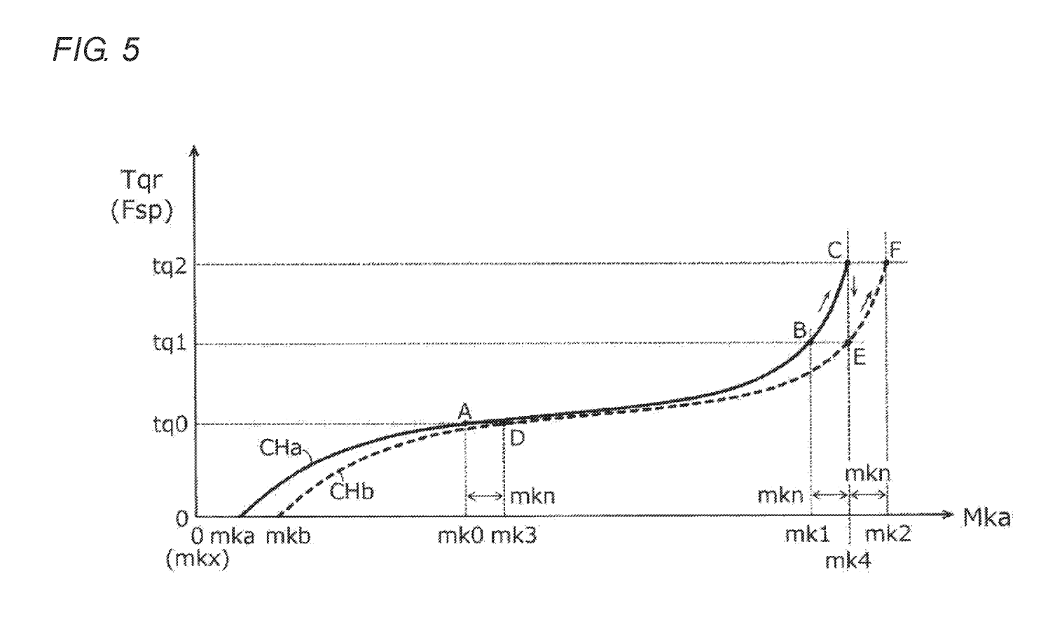

The relationship between the rotating angle and the turning torque Tqr in the returning mechanism MDK will be described below with reference to the characteristic chart in FIG. 5. With respect to the rotating angle Mka of the electric motor MTR (i.e., the input shaft SFI), the returning torque Tqr has nonlinear characteristics. The characteristics include a transition (i.e., the re-locking operation) of the contact state between the holding surface Mks and the restraint section Pks. Note that, since the returning torque Tqr is generated by the elastic force Fsp, the returning torque Tqr and the elastic force Fsp have one-to-one correspondence.

A state in which the rotating angle Mka is set to “0” corresponds to a state in which the piston PSN is the farthest from the rotating member KT (called a “rear end position of the piston PSN). The rotating angle Mka when the piston PSN is at the rear end position is called a “rear end angle mkx”. The rear end angle mkx is a predetermined value which is geometrically determined on the basis of the specifications of the actuator BRK. When “Mka=mkx”, the spiral spring SPR is not winded up, and the elastic force Fsp is not generated (i.e., “Tqr=0”).

Characteristics CHa (indicated by a solid line) are characteristics obtained in a state in which the friction member MS is brand-new and is not worn. In the characteristics CHa, a state of “Mka=mk0” corresponds to an initial position (position at which a gap between the rotating member KT and the friction member MS is almost zero) of the piston PSN. In this case, an angle mk0 is called an “initial angle”. In the returning mechanism MDK, at least the piston PSN must be drawn back to the initial position. For this reason, the returning mechanism MDK includes an error, in order to reliably achieve the drawing back of the piston PSN, setting is flexibly performed to generate an initial torque tq0 at the initial angle mk0 of the rotating angle Mka. More specifically, also when “Mka=mk0”, the initial torque tq0 acts on the electric motor MTR in the reverse direction Rvs.

The friction member MS and the piston PSN are not fixed to each other and do not move together with each other. For this reason, in the forward direction of the piston PSN, the piston PSN presses the rear plate part of the friction member MS, the piston PSN and the friction member MS move together with each other. On the other hand, in the backward direction of the piston PSN, in a range in which the friction member MS receives force from the rotating member KT, both the friction member MS and the piston PSN move together with each other. However, when the piston PSN is returned over the initial position, the piston PSN and the friction member MS (especially, the rear plate part) are separated from each other. In the state in which the piston PSN and the friction member MS are separated from each other, the gap between the friction member MS and the rotating member KT is extended by fluctuation or the like of the rotating member KT.

In the characteristics CHa, according to the increase of the rotating angle Mka, an angle mka at which the returning torque Tqr begins to increase from “0” is called a “standby angle”. The rotating angle Mka is the standby angle mka, and, in a state in which the returning torque Tqr is not generated, the hooking section Pkc formed at a position close to the internal end Se1 of the ribbon-like spiral spring SPR is stored in the cutout part having a semi-circular section of the input shaft SFI. In addition, the restraint section Pks formed at a part close to the external end Se2 of the spiral spring SPR is stored in the first holding part Bsa of the housing HSG or the second holding part Bsb. In order to lubricate the screw member NJB, the electric motor MTR is rotated in the reverse direction Rvs. When the piston PSN is drawn back such that the rotating angle Mka is closer to the rear end angle mkx than the standby angle mka, the hooking section Pkc slips out of the cutout part, and the input shaft SFI is idled with respect to the spiral spring SPR.

Even though the hooking section Pkc slips out of the cutout part, the electric motor MTR is rotated in the forward direction Fwd. When the rotating angle Mka is increased, the hooking section Pkc and the restraint section Pks are immediately locked. Furthermore, the rotating angle Mka is increased in the forward direction Fwd, the spiral spring SPR begins to generate the returning torque Tqr (rotating force in the reverse direction Rvs having the rotating axis line Jin as the center), and the returning torque Tqr is increased from “0”.

When the rotating angle Mka is further increased, the spiral spring SPR is sequentially winded, and the rotating angle Mka increases in the forward direction Fwd, accordingly, the returning torque Tqr gradually increases. In a region in which the rotating angle Mka is large, the returning torque Tqr has a characteristic having a shape being convex downward with respect to the rotating angle Mka. Thus, with respect to a small increase of the rotating angle Mka, the returning torque Tqr largely increases. On the other hand, near “Mka=mk0”, the characteristics CHa are set not to be influenced by the rotating angle Mka. More specifically, when the rotating angle Mka approximates to the initial angle mk0, the returning torque Tqr slightly changes even though the rotating angle Mka changes. For this reason, even though the friction member MS is worn to change the initial position of the piston PSN, the returning torque Tqr is almost constant at the initial position of the piston PSN.

The re-locking operation which compensates for wear of the friction member MS to hold the maximum accumulated elastic energy almost constant is executed when a parking brake operates. When the friction member MS is brand-new (i.e., when a wear amount is “0”), a state in which the parking brake increases the press force Fpa to the parking press force fpx corresponds to a point B (mk1, tq1) on an Mka-Tqr characteristic. When the wear amount of the friction member MS sequentially increases, an operation point corresponding to “Fpa=fpx” increases from the point B toward a point C along the Mka-Tqr characteristics CHa. When the wear amount of the friction member MS is large, in comparison with a case in which the wear amount of the friction member MS is small, both the rotating angle Mka and the returning torque Tqr become large with respect to the same press force (for example, the parking press force fpx).

An operation point corresponding to the parking press force fpx reaches the point C (mk2, tq2), the re-locking operation occurs. More specifically, when the returning torque Tqr exceeds the upper limit torque tq2, after the restraint section Pks and the holding surface Mks slip from each other, the restraint section Pks is not locked by the holding surface Mks. For this reason, the returning torque Tqr decreases. The returning torque Tqr higher than the upper limit torque tq2 is not generated. In this case, the upper limit torque tq2 is a preset predetermined value which is mechanically set in advance on the basis of the characteristics (spring constant or the like) and the shapes (length, plate thickness, and the like) of the spiral spring SPR and the shapes of the concave parts Bsa and Bsb (in particular, the holding surface Mks). The point C is called an “upper limit torque point”.

After the locking state of the restraint section Pks by the holding surface Mks of the first holding part Bsa (i.e., after the restraint section Pks and the holding surface Mks are not brought into contact with each other), the restraint section Pks is locked by the holding surface Mks of the second holding part Bsb again. At this time, the characteristics CHa is caused to transit (change) into characteristics CHb (indicated by a broken line). More specifically, the returning torque Tqr is not decreased until “0”, the operation point on the Mka-Tqr characteristic is caused to transit from the state at the point C to a state at a point E. A value tq1 is called a “re-locking torque”, and the point E is called a “. Furthermore, when the wear amount of the friction member MS increases, the point E increases toward point F. When the returning torque Tqr reaches the upper limit torque tq2, the characteristics CHb are changed into new characteristics again. By the re-locking operation, the Mka-Tqr characteristic is arbitrarily updated, and the function of the torque limiter is achieved.

In the change in characteristic (for example, change from the characteristics CHa to the characteristics CHb) by the re-locking operation, the shape of the Mka-Tqr characteristic is held without being change. More specifically, the Mka-Tqr characteristic, in the drawing, parallel moves by a predetermined angle mkn in the direction of the rotating angle Mka to obtain a new characteristic. The angle mkn is called a “re-locking angle”. The re-locking angle mkn is a predetermined value set in advance and determined by the number of holding parts (Bsa and the like).

### <Restraint Section Pks of Spiral Spring SPR>

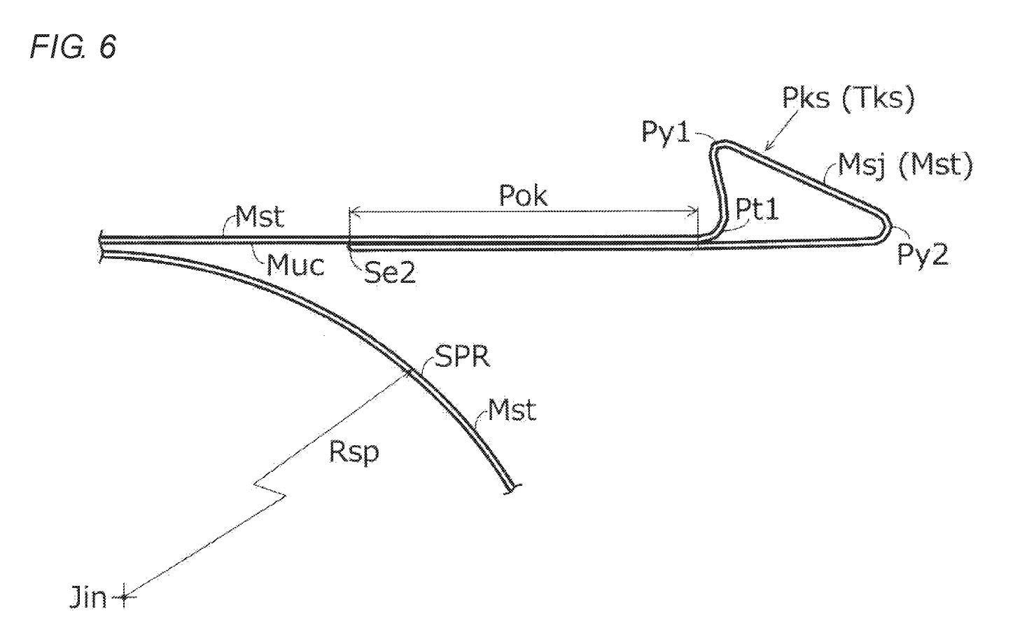

The details of the restraint section Pks of the spiral spring SPR will be described with reference to the schematic view in FIG. 6. The restraint section Pks can be shaped by using a part of the external end Se2 without fixing a new member to the spiral spring SPR. The external end Se2 is a part located on a side opposing the internal end Se1 at which the hooking section Pkc is formed in the longitudinal direction of the ribbon-like spiral spring SPR. The spiral spring SPR has the part of the external end Se2 locked by restraining the restraint section Pks on the holding surface Mks. Although the spiral spring SPR is normally winded, FIG. 6 shows a state in which the part of the external end Se2 is extended.

A part (part close to the external end Se2) extending from the external end Se2 of the spiral spring SPR and having a predetermined length is vertically bent two or more times to form the restraint section Pks with respect to the longitudinal direction of the spiral spring SPR. More specifically, in the spirally cylindrical shape of the spiral spring SPR, bent lines of a plurality of bent parts are parallel with a cylindrical generating line (segments forming a curved surface). More specifically, in a state in which the ribbon-like spiral spring SPR is straightly stretched, the first valley-folded part Pt1, the first mountain-folded part Py1, and the second mountain-folded part Py2 are bent in order from a side close to the internal end Se1 (i.e., in order from a side far from the external end Se2) such that fold lines are perpendicular (i.e., in parallel with the rotating axis line Jin of the input shaft SFI) to the longitudinal direction of the spiral spring SPR. The first valley-folded part Pt1 on which the spiral spring SPR is winded is valley-folded with respect to the outer peripheral surface Mst (mountain-folded with respect to the inner peripheral surface Muc, and the bent end is pointed at the outside of the cylindrical shape). On the other hand, the first mountain-folded part Py1 and the second mountain-folded part Py2, in a state in which the spiral spring SPR is spirally winded, is mountain-folded with respect to the outer peripheral surface Mst (valley-folded with respect to the inner peripheral surface Muc, and the bent end is pointed at the inside of the cylindrical shape). The bending angles of the first valley-folded part Pt1 and the first and second mountain-folded parts Py1 and Py2 are acute angles (less than 90 degrees). More specifically, at the part of the external end Se2 of the spiral spring SPR, in the restraint section Pks, by bending, the spiral spring SPR is perpendicularly (i.e., in parallel with the rotating axis line Jin of the shaft SFI) in the longitudinal direction, and a triangle having three angular parts (bent parts) Pt1, Py1, and Py2 is shaped. The triangle (sectional shape vertical to the rotating axis line Jin) having the bent parts Pt1, Py1, and Py2 is called the “restraint triangle Tks”.

Since the spiral spring SPR which is winded tends to extend, in a normal state, the restraint triangle Tks is stored in the first holding part Bsa or the second holding part Bsb of the housing HSG. When the rotating angle Mka increases in the forward direction Fwd to rotate the input shaft SFI, the part of the first mountain-folded part Py1 of the restraint triangle Tks is brought into contact with the holding surface Mks, and the part of the external end Se2 of the spiral spring SPR is fixed to the holding surface Mks. In this manner, the spiral spring SPR generates the elastic force Fsp to rotate the electric motor MTR in the reverse direction Rvs. Even though the energization to the electric motor MTR is stopped with the elastic force Fsp, the returning torque Tqr is given in the reverse direction Rvs of the electric motor MTR. As a result, the piston PSN is drawn back to at least the initial position, and the contact state between the friction member MS and the rotating member KT can be reliably canceled.

The restraint section Pks is brought into area contact with the pressure receiving surface Mja on the press surface Msj of the restraint triangle Tks, and the restraint section Pks is held in a locking state. In this case, the press surface Msj is the outer peripheral surface Mst between the first mountain-folded part Py1 and the second mountain-folded part Py2 in the state in which the spiral spring SPR is winded. The elastic force Fsp acts in the direction of the tangent line surface Mss. The pressure receiving surface Mja is inclined by the pressure receiving angle γ in the direction Dru approximating the rotating axis line Jin with respect to the tangent line surface Mss. For this reason, component force of the elastic force Fsp acts in the radial outer direction Drs to press the press surface Msj against the pressure receiving surface Mja. Thus, area contact between the press surface Msj and the pressure receiving surface Mja is reliably performed to avoid local force from being concentrated. As a result, simplification and light weight of the returning mechanism MDK can be achieved. In addition, the restraint section Pks is pressed by component force of the elastic force Fsp in the radial outer direction Drs such that the restraint section Pks is difficult to be slipped out of the holding surface Mks. For this reason, the locking state of the restraint section Pks can be appropriately continued.

Although the restraint section Pks (i.e., the restraint triangle Tks) is formed at a part close to the external end Se2 of the spiral spring SPR, the nipped part Pok is disposed to reliably maintain the shape (i.e., the restraint triangle Tks) of the restraint section Pks. The nipped part Pok is a part which is a part including the external end Se2 and closer to the other end Se2 than the second mountain-folded part Py2 and is nipped by the inner peripheral surface Muc and the outer peripheral surface Mst of the spiral spring SPR. More specifically, the nipped part Pok, in the state in which the spiral spring SPR is winded, is a part nipped between the inner peripheral surface Muc (inner peripheral surface Muc of a part farthest from the rotating axis line Jin, and straightly extended in FIG. 6) of the part of the spiral spring SPR located the outermost side and the outer peripheral surface Mst (outer peripheral surface Mst corresponding to the inner peripheral surface Muc, and illustrated by a radius Rsp in FIG. 6) of the part of the spiral spring SPR located on the second outermost side (see FIG. 3). When the spiral spring SPR is tightly winded, the inner peripheral surface Muc and the outer peripheral surface Mst are brought into tight contact with each other, and the part of the nipped part Pok nipped by the inner peripheral surface Muc and the outer peripheral surface Mst is tightly fixed. Since the shape of the restraint triangle Tks is reliably maintained by the nipped part Pok, the restraint section Pks appropriately functions as a structural part having charge of the elastic force Fsp.

### <Another Embodiment of Hooking Section Pkc of Spiral Spring SPR>

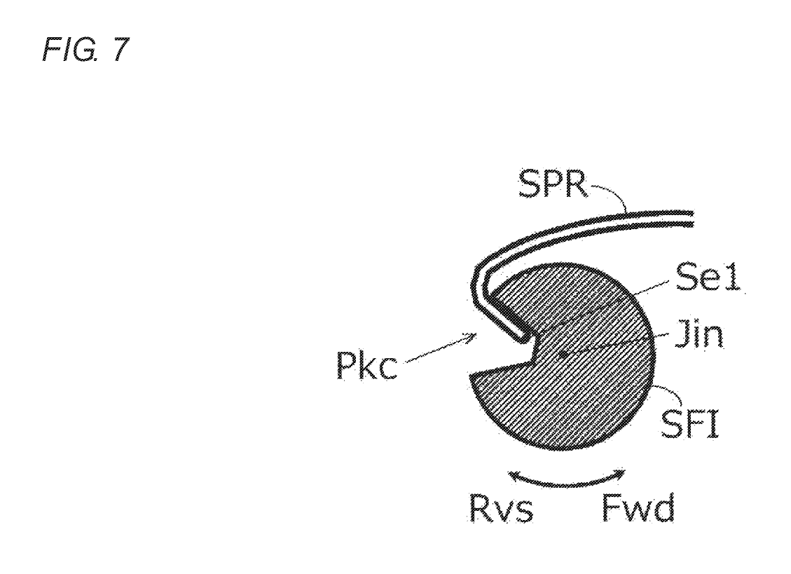

Another example of the hooking section Pkc of the spiral spring SPR will be described with reference to the schematic view in FIG. 7. In the first example of the hooking section Pkc described with reference to FIG. 3, the part of the internal end Se1 of the spiral spring SPR is bent to have a cylindrical section, and the cutout part having the semi-circular section is formed on the input shaft SFI such that the cutout part is fitted on the part of the internal end Se1. In the other example of the hooking section Pkc of the spiral spring SPR, the part of the internal end Se1 of the spiral spring SPR is bent at an acute angle. A cutout part having a V-shaped section is formed in the input shaft SFI. Also in this case, as in the first example, when the spiral spring SPR is not winded up, the hooking section Pkc is simply fitted in the V-shaped cutout part. When the input shaft SFI is rotated in the forward direction Fwd, the hooking section Pkc receives force from the V-shaped cutout part of the input shaft SFI and locked. As a result, the spiral spring SPR is winded up, and the returning torque Tqr is generated and increased. On the other hand, the input shaft SFI is rotated in the reverse direction Rvs, the hooking section Pkc is not locked on the input shaft SFI, and the spiral spring SPR is not winded. For this reason, in the reverse direction Rvs of the input shaft SFI (i.e., the electric motor MTR), the returning torque Tqr caused by the elastic force of the spiral spring SPR is not generated.

### Other Embodiments

Other embodiments will be described below.

In the embodiment, in the housing HSG, as a part locking the restraint section Pks, two parts, i.e., the first holding part Bsa and the second holding part Bsb are disposed. However, at least one holding part need only be disposed. For example, when the second holding part Bsb is omitted, in the re-locking operation, after the restraint section Pks slides on the inner peripheral surface Msp of the storing part Bsp over 360 degrees, the restraint section Pks is locked on the first holding part Bsa again. When three holding parts are disposed in the housing HSG, the restraint section Pks moves in the storing part Bsp by 120 degrees and then is locked again. More specifically, when the number of holding parts is large, a range in which torque can be limited by the re-locking operation becomes narrow. When the upper limit torque tq2 is constant, the re-locking point E comes close to the upper limit torque point C when the number of holding parts is large. For this reason, when the re-locking torque tq1 is set to a larger value to perform the re-locking operation, a change from the upper limit torque tq2 to the re-locking torque tq1 is made small. Note that a difference mkn (called a “re-locking angle”) between an angle mk1 corresponding to the re-locking torque tq1 and an angle mk2 corresponding to the upper limit torque tq2 is equal to a value obtained by dividing 360 degrees by the number of holding parts. For example, when the housing HSG is configured by two holding parts, the re-locking angle mkn is 180 degrees.

In the embodiment, the returning mechanism MDK is disposed on the input shaft SFI. However, the returning mechanism MDK is disposed on any one of the rotating members including the electric motor MTR to the piston PSN. In other words, the returning mechanism MDK is disposed on the rotating shaft (for example, the output shaft SFO) rotationally driven by the electric motor MTR. When the returning mechanism MDK is disposed on the output shaft SFO, the “SFI” and the “Jin” are replaced with the “SFO” and “Jot”, respectively to make it possible to execute the explanation.

In the embodiment, as the electric motor MTR, a brush motor is employed. However, as the electric motor MTR, a brushless motor can be used. When the brushless motor is employed, the bridge circuit BRG can be constituted by six switching elements. As in the case using the brush motor, on the basis of the duty ratio Dut, the energization states/non-energization states of the switching elements are controlled. On the basis of the actual rotating angle Mka, the six switching elements configuring a 3-phase bridge circuit are controlled. The switching elements sequentially switch the directions (i.e., excitation directions) of U-phase, V-phase, and W-phase coil energization quantity of the bridge circuit to drive the electric motor MTR.

In the embodiment, as the sectional shape of the restraint section Pks obtained by bending, the restraint triangle Tks is employed. However, the sectional shape of the restraint section Pks, a polygonal shape can be employed. For example, when a rectangle is employed, in addition to the angle parts Pt1, Py1, and Py2, a third mountain-folded part Py3 is shaped on a side approximating the external end Se2 such that the third mountain-folded part Py3 is vertical to the longitudinal direction of the spiral spring SPR (i.e., in parallel with the rotating axis lines Jin and Jot of the input shaft SFI) and valley-folded on the outer peripheral surface Mst (mountain-folded with respect to the inner peripheral surface Muc). Even in this case, a part (part including the external end Se2) between the third mountain-folded part Py3 and the external end Se2 is nipped between the inner peripheral surface Muc and the outer peripheral surface Mst of the spiral spring SPR to form the nipped part Pok. By the nipped part Pok, the polygonal shape of the restraint section Pks is strongly formed.

The embodiment exemplifies that the holding surface Mks is made of a resin material. However, the entire housing HSG including a closing member can be made of a resin material. Since the resin material has an appropriate friction coefficient, at the contact part between the restraint section Pks and the holding surface Mks, stick slip rarely occurs. For this reason, appropriate cancellation of the excessive returning torque Tqr can be achieved. Since the actuator BRK is mounted on a wheel, the actuator BRK is influenced by vibration caused by an uneven road surface. Since the vibration is also input in the directions of the rotating axis lines Jin and Jot, the bottom part of the housing HSG and the closing part are brought into contact with the side surface of the spiral spring SPR. When the resin material is employed as the material of the housing HSG, the housing HSG can be suppressed from being worn by the contact between the housing HSG and the side surface of the spiral spring SPR.

### <Operation⋅Advantage>

An electrically operated brake device for a vehicle DDS according to the present disclosure will be described below.

In the electrically operated brake device DDS, even though a power source (battery BAT or the alternator ALT) of the electric motor MTR is disordered to make it impossible to drive the electric motor MTR in the reverse direction Rvs, elastic energy accumulated in the spiral spring SPR in the returning mechanism MDK gives a returning torque in the reverse direction Rvs to the rotating shafts SFI and SFO rotationally driven by the electric motor MTR. The returning torque gives force in a backward direction to the piston PSN. As a result, even though power supply to the electric motor MTR is not performed, the piston PSN is returned to the initial position, and the contact between the friction member MS and the rotating member KT is canceled.

In the returning mechanism MDK, a part Pkc of the one end Se1 of the spiral spring SPR is locked on the rotating shafts SFI and SFO driven by the electric motor MTR. The spiral spring SPR is stored in the housing HSG. In the first and second holding parts Bsa and Bsb in the housing HSG, the holding surface Mks (one of the inner walls) extending in the radial outer direction Drs of the spiral spring SPR is formed. For example, the normal line surface Mhs is formed as the holding surface Mks. At the part of the other end Se2 located on a side opposing the one end Se1 of the spiral spring SPR, the restraint section Pks is formed. When the electric motor MTR is rotated in the forward direction Fwd (direction in which the friction member MS approximates the rotating member KT), the restraint section Pks presses the holding surface Mks almost vertically. In this manner, the spiral spring SPR gives the returning torque Tqr in the reverse direction Rvs (direction opposing the forward direction Fwd) to the electric motor MTR. More specifically, when the rotating angle Mka increases in the forward direction Fwd, since the restraint section Pks is brought into contact with the holding surface Mks, the motion (rotation) of the restraint section Pks is restrained by the housing HSG (holding surface Mks). The spiral spring SPR is tightly winded, the returning torque Tqr is generated and increased. The locking of the external end Se2 of the spiral spring SPR is achieved such that the restraint section Pks is brought into contact with the holding surface Mks extending in the radial outer direction Drs in the housing HSG. The restraint section Pks and the holding surface Mks are almost vertically contacted with each other, the returning torque Tqr can be set as a sufficiently large value with a simple configuration.

In the returning mechanism MDK, when the returning torque Tqr exceeds the predetermined upper limit torque tq2, the restraint section Pks begins to slide on the holding surface Mks in the radial inner direction Dru of the spiral spring SPR. Immediately after, the restraint section Pks slips out of the holding surface Mks and is not in contact with the holding surface Mks, and the returning torque Tqr decreases. When the spiral spring SPR is winded tightly more than a predetermined state, the radius of the spiral spring SPR decreases. By using a phenomenon which reduces the spiral spring SPR in diameter by the winding, the torque limiter function is achieved. The torque limiter function of the returning mechanism MDK can be constituted by the simplified configuration.

In the housing HSG of the returning mechanism MDK, the holding surface Msk can be formed in the radial inner direction Dru to be inclined at an angle of slide β in the forward direction Fwd with respect to the normal line surface Mhs including the “contact part (point P) between the restraint section Pks and the holding surface Mks and the rotating axis lines Jin and Jot”. As the material of the holding surface Mks, the resin material can be employed.

The locking of the radial inner direction Dru on the holding surface Mks of the restraint section Pks is achieved by static friction force between the restraint section Pks and the holding surface Mks. The frictional force (i.e., friction coefficient) is variable, a stick slip phenomenon may rarely occur. Since the holding surface Mks has the angle of slide β, when the spiral spring SPR moves in the radial inner direction Dru, the elastic energy of the spiral spring SPR is reduced, and the spiral spring SPR becomes close to a stable state of the spring. For this reason, the contact part between the restraint section Pks and the holding surface Mks can smoothly move.

In the spiral spring SPR, in the restraint section Pks can be formed such that, at the part of the other end Se2, each hold (hold line) is bent vertically to the longitudinal direction of the spiral spring SPR. For example, at the part of the other end Se2 (side opposing the one end Se1) of the spiral spring SPR, in order from a side close to the one end Se1, “the first valley-folded part Pt1 which is perpendicular to the longitudinal direction of the spiral spring SPR (in parallel with the rotating axis lines Jin and Jot) and valley-folded to the outer peripheral surface Mst of the spiral spring SPR”, “the first mountain-folded part Py1 which is perpendicular to the longitudinal direction (in parallel with the rotating axis lines Jin and Jot) and mountain-folded to the outer peripheral surface Mst”, and “the second mountain-folded part Py2 which is perpendicular to the longitudinal direction (in parallel with the rotating axis lines Jin and Jot) and mountain-folded to the outer peripheral surface Mst”. When the electric motor MTR is rotated in the forward direction Fwd, the first mountain-folded part Py1 presses the holding surface Mks, and the spiral spring SPR gives the returning torque Tqr to the electric motor MTR. Since the contact part between the spiral spring SPR and the holding surface Mks is formed by the folding process of the end part Se2 of the spiral spring SPR, the returning mechanism MDK can be simplified. In addition, since the junction part (for example, riveting) between the restraint section Pks and the spiral spring SPR is omitted, the strength of the entire spiral spring SPR can be improved.

In the interior (inner wall) of the housing HSG, the pressure receiving surface Mja can be formed to be inclined by the pressure receiving angle γ in the radial inner direction Dru of the spiral spring SPR with respect to the tangent line surface Mss formed by “the tangent line Lss of the arc Len passing through the contact part (point P) between the holding surface Mks and the first mountain-folded part Py1 and having the rotating axis lines Jin and Jot as the center”. The press surface Msj serving as the outer peripheral surface Mst between the first mountain-folded part Py1 and the second mountain-folded part Py2 is pressed against the pressure receiving surface Mja. The restraint section Pks receives the elastic force Fsp in the direction parallel to the tangent line surface Mss at the first mountain-folded part Py1. Since the elastic force Fsp acts as a moment around the first valley-folded part Pt1 to stretch the first valley-folded part Pt1 which is valley-folded, the shape of the restraint triangle Tks is difficult to be kept. However, the moment generated by the elastic force Fsp around the first valley-folded part Pt1 is supported by area contact between the press surface Msj and the pressure receiving surface Mja. For this reason, the restraint triangle Tks is suppressed from being deformed, and the restraint triangle Tks is kept in an almost constant shape.

Since the pressure receiving surface Mja is inclined by the pressure receiving angle γ in the radial inner direction Dru with respect to the tangent line surface Mss, the elastic force Fsp acts on the tangent line surface Mss in the radial outer direction Drs. Since component force of the elastic force Fsp presses the press surface Msj of the restraint section Pks against the pressure receiving surface Mja, area contact between the press surface Msj and the pressure receiving surface Mja is reliably executed to avoid local force from being concentrated. As a result, the returning mechanism MDK can be simplified and reduced in weight. In addition, the restraint section Pks is pressed by the component force of the elastic force Fsp in the radial outer direction Drs such that the restraint section Pks is difficult to slip out of the holding surface Mks. For this reason, even though disturbance such as road vibration acts on the actuator BRK, the locking state of the restraint section Pks can be reliably maintained.

The spiral spring SPR is configured such that the part Pok closer to the other end Se2 than the first mountain-folded part Py1 is nipped by the inner peripheral surface Muc and the outer peripheral surface Mst of the spiral spring SPR. When the spiral spring SPR is winded up, the inner peripheral surface Muc and the outer peripheral surface Mst of the spiral spring SPR come close to each other. The nipped part Pok sandwiched between the inner peripheral surface Muc and the outer peripheral surface Mst strongly keeps the shape of the restraint triangle Tks, and the spiral spring SPR reliably functions are a structural member having charge of the elastic force Fsp.

1. (canceled)

2. (canceled)

3. (canceled)

4. (canceled)

5. (canceled)

6. (canceled)

7. (canceled)

8. An electrically operated brake device for a vehicle comprising:
an electric motor pressing friction member against a rotating member rotating together with a wheel of the vehicle; and
a returning mechanism moving the friction member in a direction away from the rotating member when the electric motor is not energized,
wherein
the returning mechanism includes
a spiral spring having a part of one end locked on a rotating shaft driven by the electric motor, and
a housing which stores the spiral spring and in which a holding surface extending in a radial outer direction of the spiral spring is formed,
a restraint section is formed at a part of the other end located on a side opposing the one end of the spiral spring,
when the electric motor is rotated in a forward direction which is a direction causing the friction member to come close to the rotating member,
the restraint section presses the holding surface, and
the spiral spring gives a returning torque in a reverse direction opposing the forward direction,
wherein, when the returning torque exceeds a predetermined torque, the restraint section slips out of the holding surface to decrease the returning torque, and
wherein the holding surface is formed in the radial inner direction of the spiral spring to be inclined in the forward direction with respect to a normal line surface including a contact part between the restraint section and the holding surface and an axis line of the rotating shaft.

9. The electrically operated brake device for a vehicle according to claim 8, wherein the restraint section is formed such that the part of the other end is bent perpendicularly to the longitudinal direction of the spiral spring.

10. An electrically operated brake device for a vehicle comprising:
an electric motor pressing friction member against a rotating member rotating together with a wheel of the vehicle; and
a returning mechanism moving the friction member in a direction away from the rotating member when the electric motor is not energized,
wherein
the returning mechanism includes
a spiral spring having a part of one end locked on a rotating shaft driven by the electric motor, and
a housing which stores the spiral spring and in which a holding surface extending in a radial outer direction of the spiral spring is formed,
at a part of the other end located on a side opposing the one end of the spiral spring, in order from a side close to the one end, “a first valley-folded part valley-folded perpendicularly to the longitudinal direction of the spiral spring with respect to an outer peripheral surface of the spiral spring”, “a first mountain-folded part mountain-folded perpendicularly to the longitudinal direction with respect to the outer peripheral surface”, and “a second mountain-folded part mountain-folded perpendicularly to the longitudinal direction with respect to the outer peripheral surface” are formed, and
when the electric motor is rotated in the forward direction which is a direction causing the friction member to come close to the rotating member,
the first mountain-folded part presses the holding surface, and
the spiral spring gives a returning torque in a reverse direction opposing the forward direction to the electric motor.

11. The electrically operated brake device for a vehicle according to claim 10, wherein
the housing includes a pressure receiving surface inclined in the radial inner direction of the spiral spring with respect to the tangent line surface formed by a tangent line of an arc passing through a contact part between the holding surface and the first mountain-folded part and having an axis line of the rotating shaft as the center, and
wherein the outer peripheral surface between the first mountain-folded part and the second mountain-folded part is pressed against the pressure receiving surface.

12. The electrically operated brake device for a vehicle according to claim 10, wherein a part closer to the other end than the first mountain-folded part of the spiral spring is nipped by an inner peripheral surface and the outer peripheral surface of the spiral spring.

13. The electrically operated brake device for a vehicle according to claim 11, wherein a part closer to the other end than the first mountain-folded part of the spiral spring is nipped by an inner peripheral surface and the outer peripheral surface of the spiral spring.
